(19) United States
(12) Patent Application Publication
(10) Pub. No.: US 2019/0231056 A1
(43) Pub. Date: Aug. 1, 2019

(54) HANDS-FREE ACTIVE USE PHOTOGRAPHIC MOUNTING APPARATUS

(71) Applicant: Peter K. Martin, Northglenn, CO (US)

(72) Inventor: Peter K. Martin, Northglenn, CO (US)

(21) Appl. No.: 16/222,812

(22) Filed: Dec. 17, 2018

Related U.S. Application Data
(60) Provisional application No. 62/623,911, filed on Jan. 30, 2018.

(51) Int. Cl. A45F 5/00; F16M 13/04

(52) U.S. Cl. CPC A45F 5/00; F16M 13/04; A45F 2200/0525; F16M 2200/04; A45F 2200/0533

(57) ABSTRACT

A hands-free photographic apparatus includes a shoulder mount positionable on a user's shoulder, a rod operable to balance on the shoulder mount, and a strap connected to an attachment point located on a user's torso and the second end of the rod. The shoulder mount may include a first securement mechanism. The rod may include a first end, a second end, a photographic device mount coupled to the first end such that the photographic device mount is operable to suspend a photographic device from the rod when the rod is positioned on the shoulder mount and the shoulder mount is positioned on the user's shoulder, and a second securement mechanism positioned between the first end and the second end that is operable to engage the first securement mechanism to secure the rod to the shoulder mount. The strap may be operable to counterbalance the photographic device.

### CROSS-REFERENCE TO RELATED APPLICATION

This application is a non-provisional patent application of and claims the benefit to U.S. Provisional Patent Application No. 62/623,911, filed Jan. 30, 2018, and titled “Hands-Free Active Use Photographic Mounting Apparatus,” the disclosure of which is hereby incorporated herein by reference in its entirety.

### FIELD

The described embodiments relate generally to photographic apparatuses. More particularly, the present embodiments relate to a hands-free apparatus for using photographic equipment, such a smart phone, during activities, such as fishing.

### BACKGROUND

People record moments of their lives and/or events of the world using a variety of different devices. Some use video or still cameras or other photographic devices in order to create remembrances, share with others, and/or for a variety of other purposes. This has increased with the prevalence of digital cameras as people do not even have to use up film in order to record.

Many people may use cameras or other devices to record images of themselves. Various mechanisms have been created to avoid people having to obtain the services of other people to operate the camera. In this way, people can effectively be “behind” and “in front of” cameras at essentially the same time.

For example, cameras with recording timers were developed. A person could set the timer and then position themselves in front of the camera in order for an image of them to be captured when the timer went off. Similarly, mounting apparatuses, such as “selfie sticks,” were developed that allowed people to hold cameras or other photographic devices, such as smart phones or other mobile computing devices, at a particular position with respect to themselves in order to capture images.

### SUMMARY

The present disclosure relates to a hands-free apparatus for using photographic equipment, such a smart phone, during activities, such as fishing. The hands-free photographic apparatus may include a rod, shaft, or other photographic device mounting member that is operable to rest on a user's shoulder and suspend a photographic device on a first end in front of the user at a distance and position where it may be usable to record one or more images of the user. The hands-free photographic apparatus may also include a strap, restraint, or other counterbalance mechanism that exerts a downward force or otherwise counterbalances or restricts motion of the hands-free apparatus off of the user's shoulder caused by the photographic device. The hands-free photographic apparatus may further include a shoulder mount, securement mechanisms, restraining portions, or other grip mechanism that secures, prevents sliding, or otherwise restricts motion of the hands-free photographic apparatus on the user's shoulder. The hands-free photographic apparatus may be quickly and simply assembled and disassembled and allow use of the photographic device while a user engages in various activities, such as fishing.

In some implementations, a hands-free photographic apparatus includes a shoulder mount positionable on a user's shoulder, a rod operable to balance on the shoulder mount, and a strap connected to an attachment point located on a user's torso and the second end of the rod. The shoulder mount includes a first securement mechanism. The rod includes a first end, a second end, a photographic device mount coupled to the first end such that the photographic device mount is operable to suspend a photographic device from the rod when the rod is positioned on the shoulder mount and the shoulder mount is positioned on the user's shoulder, and a second securement mechanism positioned between the first end and the second end that is operable to engage the first securement mechanism to secure the rod to the shoulder mount. The strap may be operable to counterbalance the photographic device.

In various examples, the shoulder mount is configured to couple to a shoulder strap. In numerous examples, the first and second securement mechanisms include a set of interacting hook-and-loop fasteners. In some examples, the first and second securement mechanisms include a set of interacting magnets. In various examples, the rod is a telescoping rod. In some examples, the strap includes a loop that wraps around the second end of the rod. In numerous examples, the attachment point is a belt loop and the strap includes a loop that wraps around the belt loop.

In various implementations, a hands-free photographic apparatus includes a shaft positionable on a user's shoulder. The shaft includes a photographic device mount coupled to a first end of the shaft that is operable to suspend a photographic device from the shaft and a restraining portion operable to restrict motion of the shaft when the shaft is positioned on the user's shoulder. The hands-free photographic apparatus also includes a counterbalance mechanism connected to the user's torso and a second end of the shaft that resists a downward force exerted on the first end of the shaft by the photographic device.

In some examples, the counterbalance mechanism includes a clip that is operable to engage an aperture in a clip mount rotatably attached to the second end of the shaft. In various examples, the counterbalance mechanism is removably connected to the second end of the shaft. In numerous examples, the second end of the shaft is configured to resist disconnection of the counterbalance mechanism.

In various examples, the counterbalance mechanism includes a first set of hook-and-loop fasteners and a second set of hook-and-loop fasteners. In some examples, the photographic device is a cellular telephone. In various examples, the shaft is configurable between a first length and a second length.

In numerous implementations, a hands-free photographic apparatus includes a photographic device mounting member configured to rest on a user's shoulder, suspend a photographic device on a first side of the user's shoulder, and extend over a second side of the user's shoulder; a restraint connected to the user's waist and the portion of the photographic device mounting member extending over the second side of the user's shoulder, the restraint restricting motion of the photographic device mounting member off of the user's shoulder caused by the photographic device; and a grip mechanism that prevents sliding of the photographic device mounting member on the user's shoulder.

In some examples, the photographic device mounting member allows repositioning of the photographic device with respect to the user while resting on the user's shoulder. In various examples, the restraint compensates the photographic device mounting member for a weight of the photographic device. In some cases of such examples, the restraint is operable to compensate the photographic device mounting member for the weight of the photographic device at multiple distances from the user.

In numerous examples, the restraint is a stretchable cord. In various examples, the photographic device is a mobile computing device.

### BRIEF DESCRIPTION OF THE DRAWINGS

The disclosure will be readily understood by the following detailed description in conjunction with the accompanying drawings, wherein like reference numerals designate like structural elements.

FIG. 1A depicts a hands-free photographic apparatus.

FIG. 1B depicts the hands-free photographic apparatus of FIG. 1A with the backpack removed for clarity.

FIG. 1C depicts a close up of the rod of FIG. 1A.

FIG. 1D depicts the rod of FIG. 1C telescoped closed.

FIG. 1E depicts the rod of FIG. 1C with the webbing removed so that the photographic device can be removed from the photographic device mount of the rod.

FIG. 1F depicts a close up of the shoulder mount of FIG. 1A.

FIG. 1G depicts the shoulder mount of FIG. 1F opened.

FIG. 1H depicts a close up of the strap of FIG. 1A.

FIG. 1I depicts the strap of FIG. 1H with both ends opened.

FIG. 2 depicts an alternative embodiment of the securement mechanisms between the rod and the shoulder mount.

FIG. 3 depicts a first alternative embodiment of connection between the rod and the strap.

FIGS. 4A-4B depict a second alternative embodiment of connection between the rod and the strap.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems and apparatuses that embody various elements of the present disclosure. However, it should be understood that the described disclosure may be practiced in a variety of forms in addition to those described herein.

The following disclosure relates to a hands-free apparatus for using photographic equipment, such a smart phone, during activities, such as fishing. The hands-free photographic apparatus may include a rod, shaft, or other photographic device mounting member that is operable to rest on a user's shoulder and suspend a photographic device on a first end in front of the user at a distance and position where it may be usable to record one or more images of the user. The hands-free photographic apparatus may also include a strap, restraint, or other counterbalance mechanism that exerts a downward force or otherwise counterbalances or restricts motion of the hands-free apparatus off of the user's shoulder caused by the photographic device. The hands-free photographic apparatus may further include a shoulder mount, securement mechanisms, restraining portions, or other grip mechanism that secures, prevents sliding, or otherwise restricts motion of the hands-free photographic apparatus on the user's shoulder. The hands-free photographic apparatus may be quickly and simply assembled and disassembled and allow use of the photographic device while a user engages in various activities, such as fishing.

In some embodiments, a hands-free photographic apparatus includes a shoulder mount positionable on a user's shoulder, the shoulder mount including a first securement mechanism; a rod operable to balance on the shoulder mount, the rod including a first end, a second end, a photographic device mount coupled to the first end such that the photographic device mount is operable to suspend a photographic device from the rod when the rod is positioned on the shoulder mount and the shoulder mount is positioned on the user's shoulder, and a second securement mechanism positioned between the first end and the second end that is operable to engage the first securement mechanism to secure the rod to the shoulder mount; and a strap connected to an attachment point located on a user's torso and the second end of the rod, the strap may be operable to counterbalance the photographic device.

In various embodiments, a hands-free photographic apparatus includes a shaft positionable on a user's shoulder, the shaft including a photographic device mount coupled to a first end of the shaft that is operable to suspend a photographic device from the shaft, and a restraining portion operable to restrict motion of the shaft when the shaft is positioned on the user's shoulder; and a counterbalance mechanism connected to the user's torso and a second end of the shaft that resists a downward force exerted on the first end of the shaft by the photographic device.

In numerous embodiments, a hands-free photographic apparatus includes a photographic device mounting member configured to rest on a user's shoulder, suspend a photographic device on a first side of the user's shoulder, and extend over a second side of the user's shoulder; a restraint connected to the user's waist and the portion of the photographic device mounting member extending over the second side of the user's shoulder, the restraint restricting motion of the photographic device mounting member off of the user's shoulder caused by the photographic device; and a grip mechanism that prevents sliding of the photographic device mounting member on the user's shoulder.

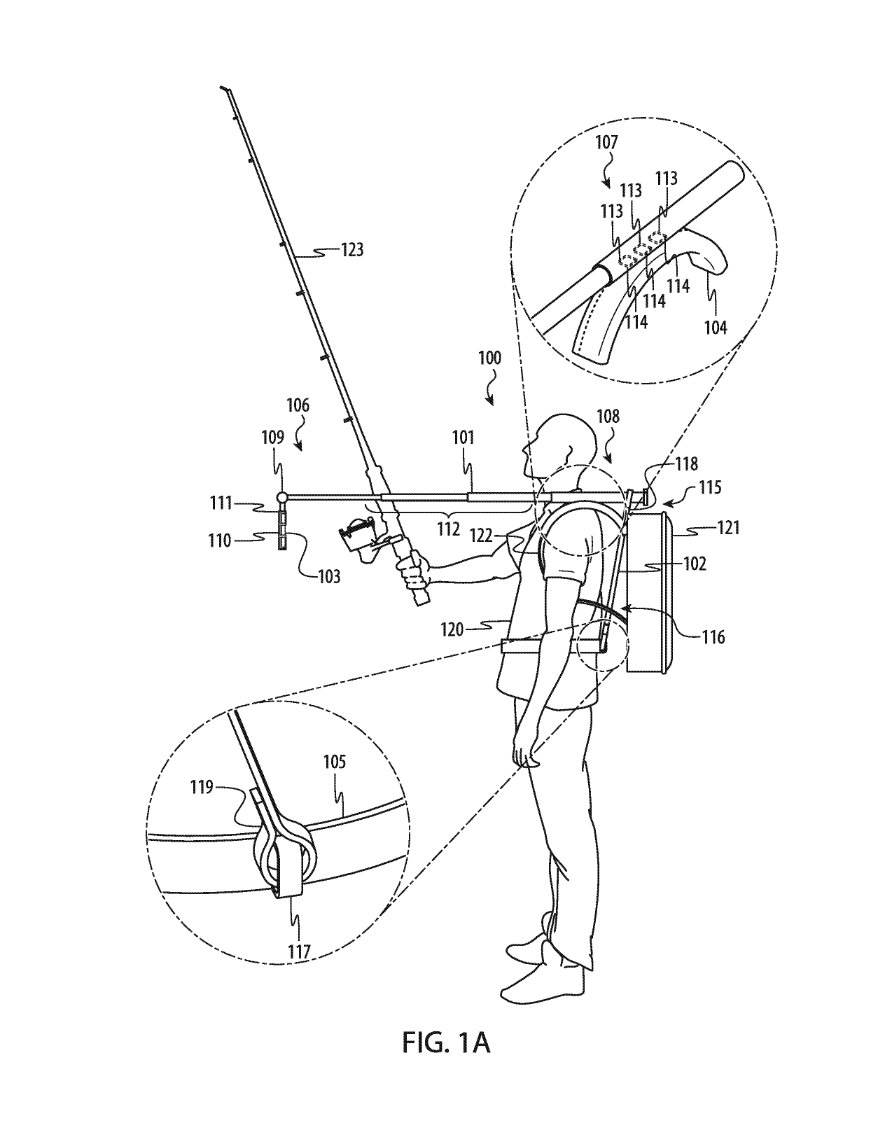

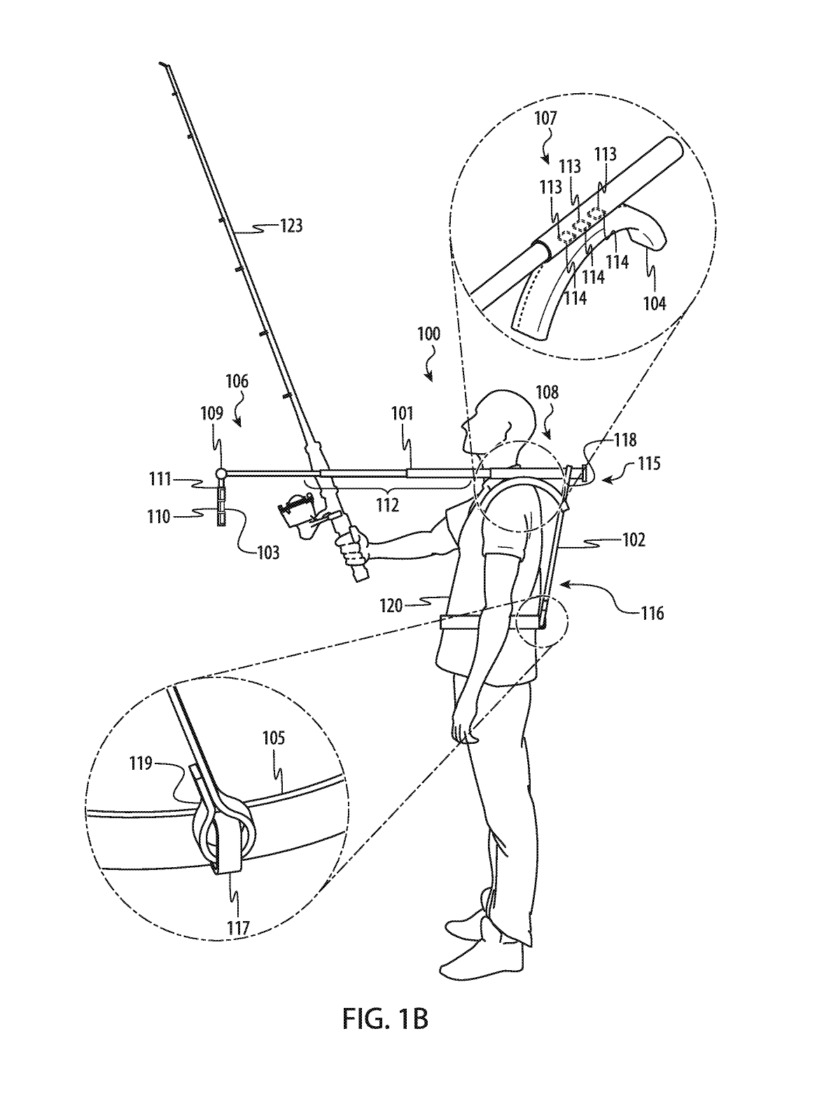

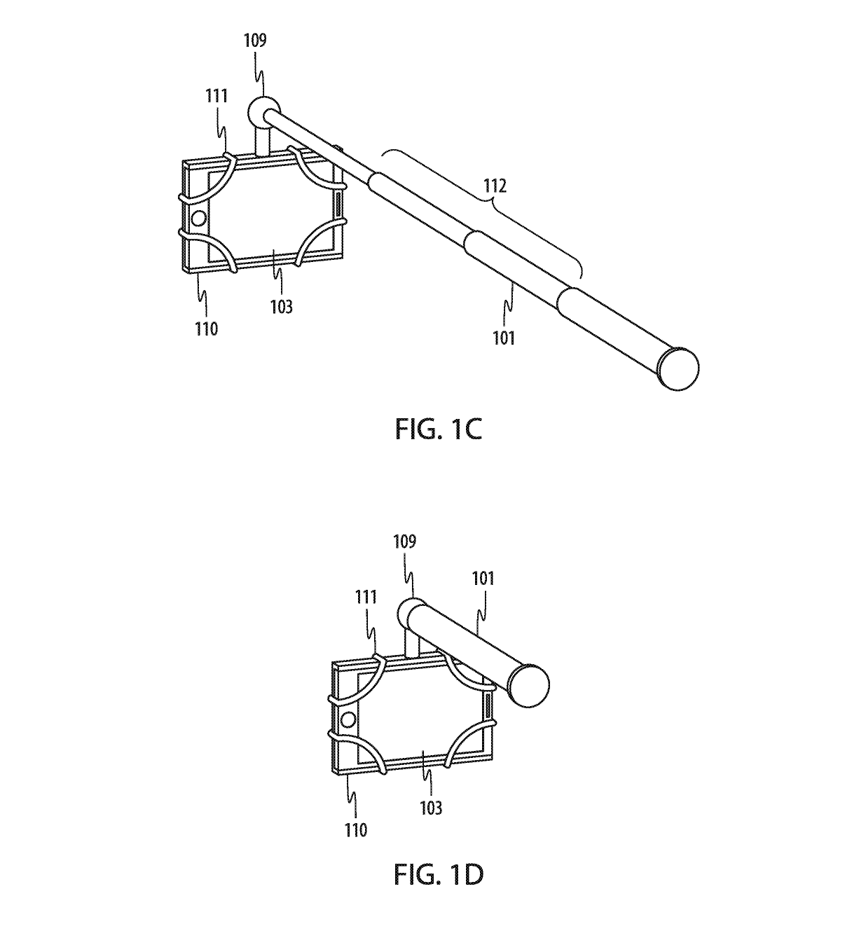

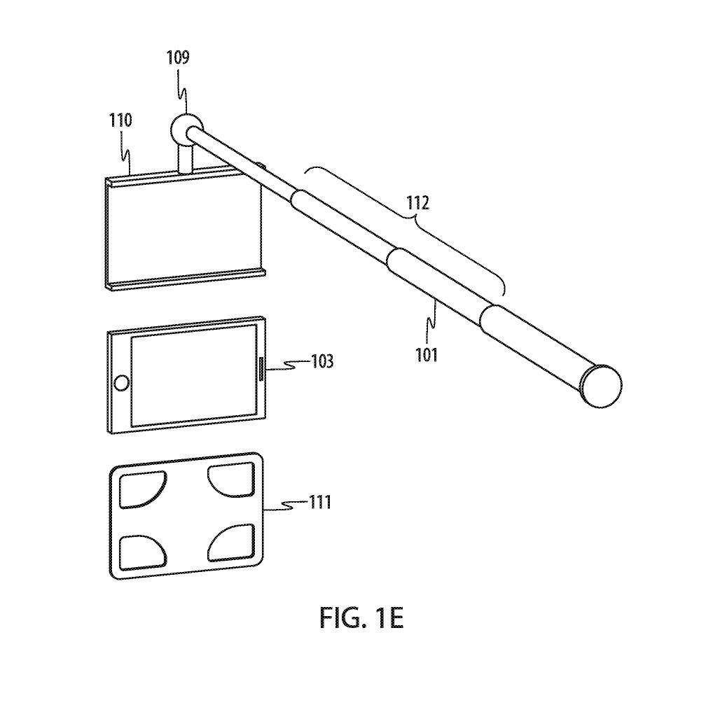

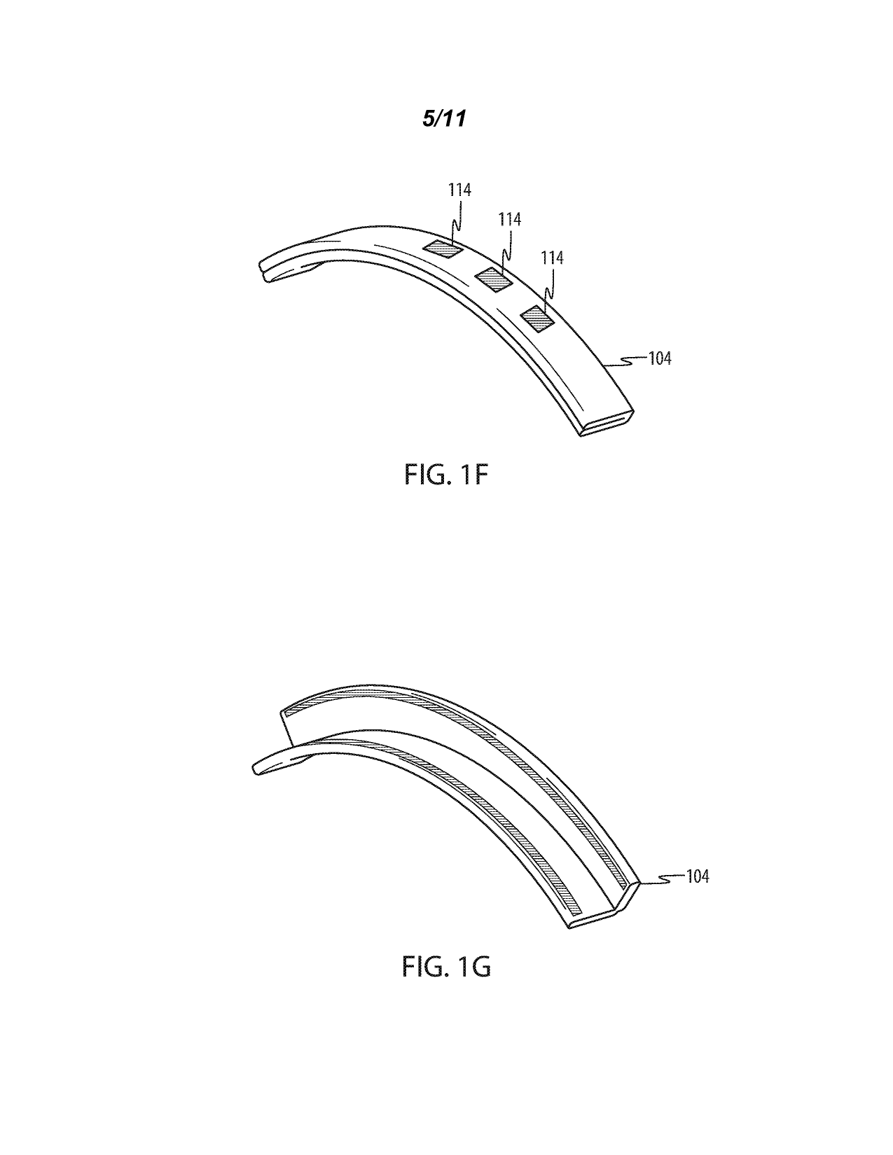

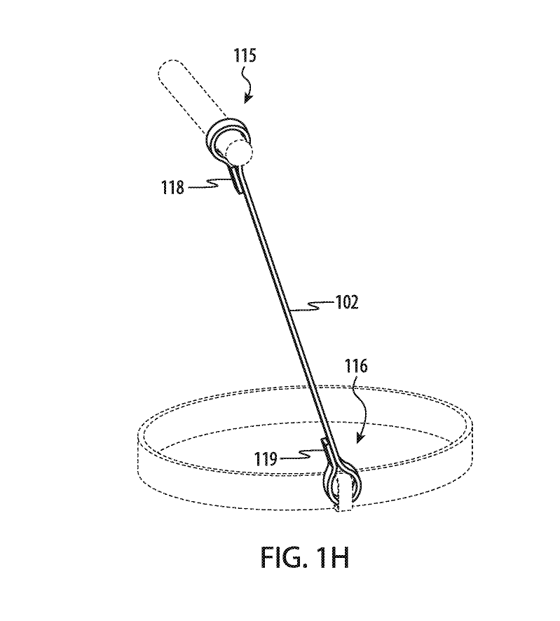

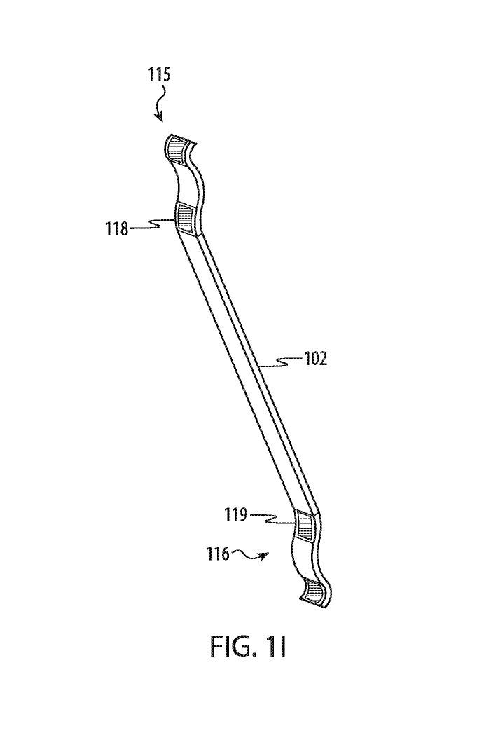

These and other embodiments are discussed below with reference to FIGS. 1-4. However, those skilled in the art will readily appreciate that the detailed description given herein with respect to these Figures is for explanatory purposes only and should not be construed as limiting.

FIG. 1A depicts a hands-free photographic apparatus 100. The hands-free photographic apparatus 100 may include a rod 101 (or a shaft, photographic device mounting member, selfie stick, and so on), a shoulder mount 104 (or restraining portion, grip mechanism, and so on), and a strap 102 (or counterbalance mechanism, restraint).

The rod 101 may be configured to balance, be positionable on, or rest on the shoulder mount 104, which may itself be positionable on the user's shoulder. The rod 101 may have a first end 106, a second end 108, and a photographic device mount 110 coupled to the first end 106 such that the rod 101 is operable to suspend a photographic device 103 from the rod 101 when the rod 101 is positioned on the shoulder mount 104 and the shoulder mount 104 is positioned on the user's shoulder. The first end 106 of the rod 101 may suspend the photographic device 103 over a first side of the user's shoulder while the second end 108 of the rod 101 extends over a second side of the user's shoulder, as shown.

The strap 102 may be operable to counterbalance the photographic device 103 (e.g., compensates the rod 101 for the weight of the photographic device 103). For example, the strap 102 may counterbalance the photographic device 103 by exerting a downward force on the second end 108 of the rod 101, resisting a downward force exerted on the first end 106 of the rod 101 by the photographic device 103, restricting motion of the rod 101 off of the user's shoulder caused by the photographic device 103, and so on. The strap 102 may be connected to the rod 101 in order to perform these functions. A first end 115 of the strap 102 may be connected to the rod 101. In this example, the first end 115 of the strap 102 forms a loop that wraps around the second end 108 of the rod 101.

The strap 102 may also be connected to an attachment point 117 located on a user's torso. For example, as shown, the attachment point 117 may be a loop of the user's belt 105 (though it may also be a clip on hip waders, a belt loop on the user's pants, and/or any other attachment point that may be connected directly or indirectly to the user's torso). As shown, the second end 116 of the strap 102 may wrap around the loop of the user's belt 105.

The shoulder mount 104 and/or the rod 101 may be configured to secure the rod 101 on the user's shoulder. For example, the shoulder mount 104 may be configured to secure the rod 101 to the shoulder mount 104, prevent the rod 101 from sliding on the user's shoulder or the shoulder mount 104, restrict motion of the rod 101 when the rod 101 is positioned on the user's shoulder or the shoulder mount 104, and so on. For example, the shoulder mount 104 may include a first securement mechanism 114 and the rod 101 may include a second securement mechanism 113 that is operable to engage the first securement mechanism 114 to secure the rod 101 to the shoulder mount 104. The second securement mechanism 113 of the rod 101 may be positioned between the first end 106 and the second end 108, such as on an underside of a middle portion 107 of the rod 101 as shown. In this example, the first securement mechanism 114 and the second securement mechanism 113 may be interacting hook-and-loop fasteners (i.e., first and second sets of hook-and-loop fasteners such as those sold under the name Velcro™).

The rod 101 may be configured to suspend the photographic device 103 from an underside of the rod 101 when the rod 101 is positioned on the shoulder mount 104. For example, the photographic device mount 110 may be coupled to the first end 106 of the rod 101 by a ball joint 109. This ball joint 109 may allow the photographic device mount 110 to be fixed in place with respect to the user 120 on the underside of the rod 101 while the user 120 fishes with a fishing rod 123 or performs other activities.

As the second securement mechanism 113 is also positioned on the underside of the middle portion 107 of the rod 101, the weight of the photographic device 103 and the second securement mechanism 113 may cooperate to stabilize the hands-free photographic apparatus 100. This may also help to secure the rod 101 to the shoulder mount 104, prevent sliding or unintended rod 101 motion, and so on.

However, it is understood that these are examples. In various implementations, the rod 101 may be configured such that the photographic device is mounted on an upper side of the rod 101 rather than suspended from the underside. Various configurations are possible and contemplated without departing from the scope of the present disclosure.

The rod 101 may be a telescoping rod and/or other rod including various mechanisms that allow for the rod to have a variable length. For example, as shown, the rod 101 may include a telescoping portion 112. The telescoping portion 112 may enable the rod 101 to be adjusted between an extended (shown) and a retracted length, such as between approximately three feet and a half foot in length, and various lengths in between (between a first length and a second length, between various lengths, and so on). This may allow the rod 101 to be easily stored or transported, and may allow the photographic device 103 to be positioned at various distances from the user 120. The telescoping portion 112 may allow for repositioning of the photographic device 103 with respect to the user 120 while the rod 101 is resting and/or otherwise positioned on the user's shoulder.

As the strap 102 may be operable to counterbalance the rod 101 for the photographic device 103 and the rod 101 may be adjusted to position the photographic device at multiple different distances from the user 120, the strap may be operable to compensates the rod 101 for the weight of the photographic device 103 at multiple distances from the user 120. This may allow the hands-free photographic apparatus 100 to be more versatile and be used to take a greater variety of pictures than might otherwise be possible.

The shoulder mount 104 may be a pad or other device that is operable to attach to a shoulder strap 122. For example, as shown, the shoulder mount 104 is a pad that attaches around the shoulder strap 122 of the backpack 121, but may be used with other shoulder straps such as those of hip waders, suspenders, and so on. The pad may also be positioned on the user's shoulder without attaching to or around a shoulder strap 122. However, it is understood that this is an example. In various implementations, the shoulder mount 104 may be otherwise configured. For example, the shoulder mount 104 may be the shoulder portion of a shirt, jacket, or other apparatus that positions a structure that functions as the shoulder mount 104 on the user's shoulder.

The strap 102 may be a single piece of material that is stretchable and includes a first closure 118 and a second closure 119 to allow loops to be formed at both the first end 115 and the second end 116 of the strap. These loops may allow the strap 102 to wrap around the attachment point 117 and the second end 108 of the rod 101.

The photographic device mount 110 may be configured in a variety of different ways to couple to the photographic device 103 and/or allow the photographic device 103 to couple to it. In this example, the photographic device mount 110 may be a bracket that the photographic device 103 fits into and a webbing 111 may be stretched around the photographic device mount 110 and the photographic device 103 to removably secure the photographic device 103 to the photographic device mount 110.

In some implementations, the second end 108 of the rod 101 may be configured to resist removal of the strap 102. For example, as shown, the second end 108 of the rod 101 may be flanged so that the loop formed by the first end 115 of the strap 102 may not slip off unintentionally. In other examples, the second end 108 of the rod 101 may define an aperture to which a clip of the strap 102 may be coupled that may resist unintentional removal of the strap 102. Various configurations are possible and contemplated without departing from the scope of the present disclosure.

Thus, the rod 101, the strap 102, the photographic device 103, the shoulder mount 104, and so on may all be removably connected to each other. This may allow the hands-free photographic apparatus 100 to be quickly and simply assembled and disassembled.

As shown, the photographic device 103 is shown as a smart phone or cellular telephone. However, it is understood that this is an example. In various implementations, the photographic device 103 may be any kind of photographic component such as a mobile computing device, a tablet computer, a camera, a video camera, and so on. The photographic device 103 may be activated to record one or more images or pictures using one or more voice commands, remote control devices, timers, and so on.

In the above ways, the hands-free photographic apparatus 100 may be quickly and simply assembled and disassembled for transport, storage, and use. The hands-free photographic apparatus 100 may allow the user 120 to position and maintain the photographic device 103 at a particular point with respect to themselves in order to capture one or more images or pictures without interfering with performance of activities, such as fishing.

FIG. 1B depicts the hands-free photographic apparatus 100 of FIG. 1A with the backpack 121 removed for clarity. As shown, the hands-free photographic apparatus 100 may be used without connecting the shoulder mount 104 to a shoulder strap of the backpack 121 or other similar device.

FIG. 1C depicts a close up of the rod 101 of FIG. 1A. FIG. 1D depicts the rod 101 of FIG. 1C telescoped closed. FIG. 1E depicts the rod 101 of FIG. 1C with the webbing 111 removed so that the photographic device 103 can be removed from the photographic device mount 110 of the rod 101.

FIG. 1F depicts a close up of the shoulder mount 104 of FIG. 1A. FIG. 1G depicts the shoulder mount 104 of FIG. 1F opened. As shown, the shoulder mount 104 may include a single piece of material that folds and clasps using one or more sets of interacting hook-and-loop fasteners. This may allow the shoulder mount 104 to attach around and/or couple to one or more shoulder straps or other devices. However, it is understood that this is an example. In various implementations, the shoulder mount 104 may be otherwise structured without departing from the scope of the present disclosure.

FIG. 1H depicts a close up of the strap 102 of FIG. 1A. FIG. 1I depicts the strap 102 of FIG. 1H with both ends 115, 116 opened.

Although the above illustrates and describes the hands-free photographic apparatus 100 as including particular components arranged in a particular configuration, it is understood that this is an example. In various implementations, various configurations of the same, similar, and/or different components may be arranged in various ways without departing from the scope of the present disclosure.

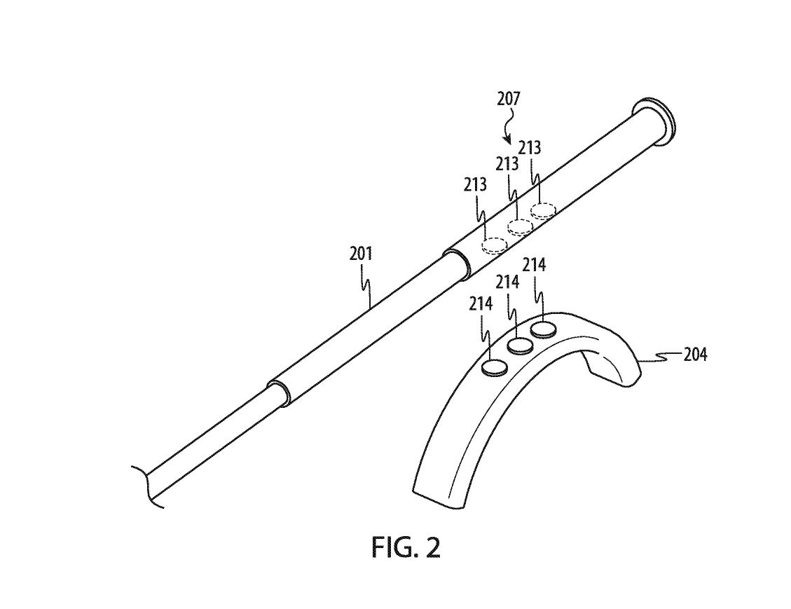

For example, the above illustrates and describes the first securement mechanism 114 and the second securement mechanism 113 as interacting hook-and-loop fasteners. However, it is understood that this is an example. FIG. 2 depicts an alternative embodiment of the securement mechanisms 214, 213 between the rod 201 and the shoulder mount 204. In this alternative embodiment, the first securement mechanism 214 and the second securement mechanism 213 as interacting magnets. Various devices may be used for the securement mechanisms 214, 213 without departing from the scope of the present disclosure.

By way of another example, returning to FIG. 1A, the above illustrates and describes the strap 102 connecting to the second end 108 of the rod 101 by wrapping a loop formed by the first end 115 of the strap around the second end 108 of the rod 101. However, it is understood that other implementations are possible and contemplated.

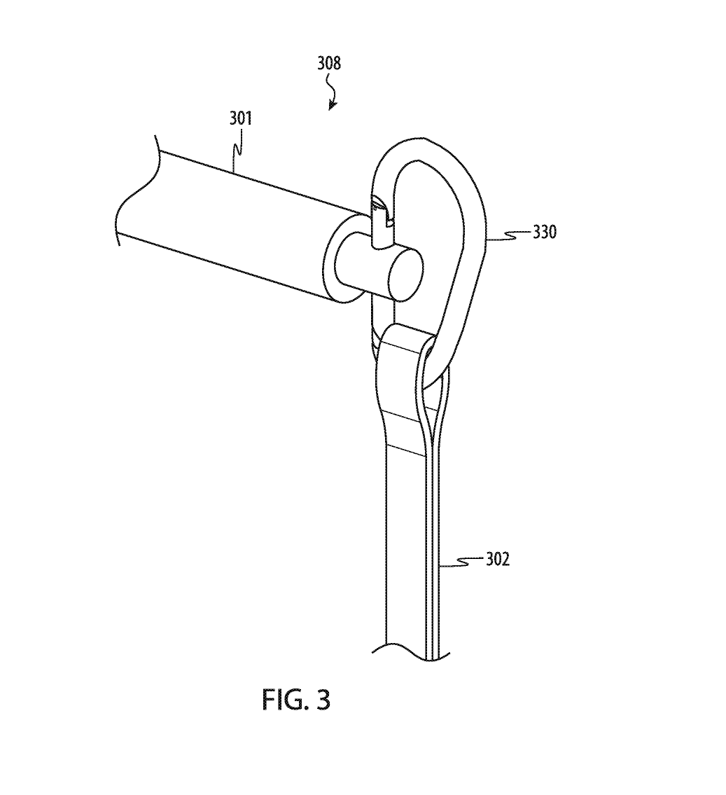

For example, FIG. 3 depicts a first alternative embodiment of connection between the rod 301 and the strap 302. In this alternative embodiment, the second end 308 of the rod 301 includes a swivel bearing or other clip mount that defines an aperture and the first end 315 of the strap 302 includes a clip 330 that is operable to attach to the aperture of the swivel bearing.

The clip 330 and the swivel bearing may resist removal of the strap 302 from the second end 308 of the rod 301. The clip 330 may be first opened and then withdrawn from the swivel bearing. Downward force on the swivel bearing by the clip during use may prevent the swivel bearing from rotating and allowing motion of the rod 301, but the swivel bearing may rotate when the apparatus is not in use to allow motion of the swivel bearing and/or the clip 330 for adjustment of various components with respect to each other.

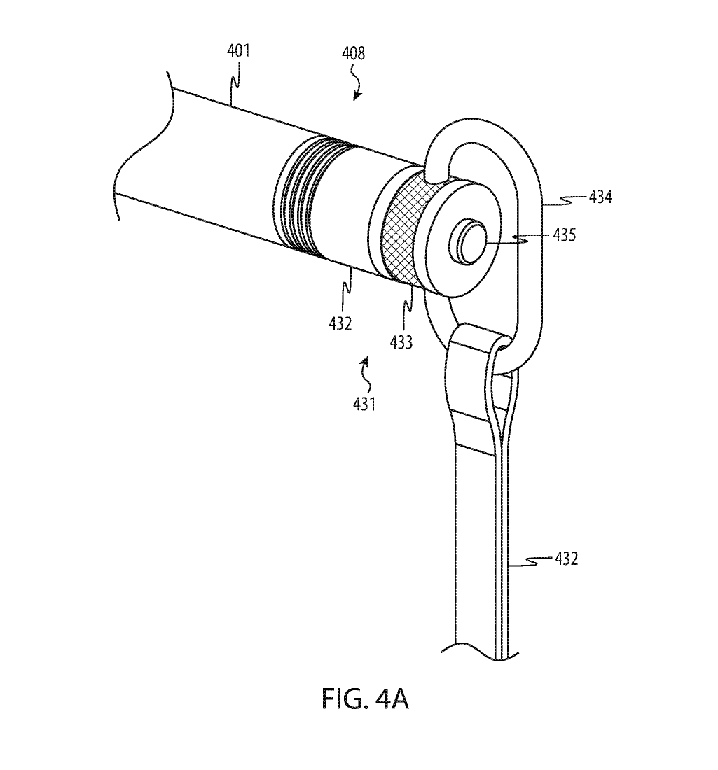

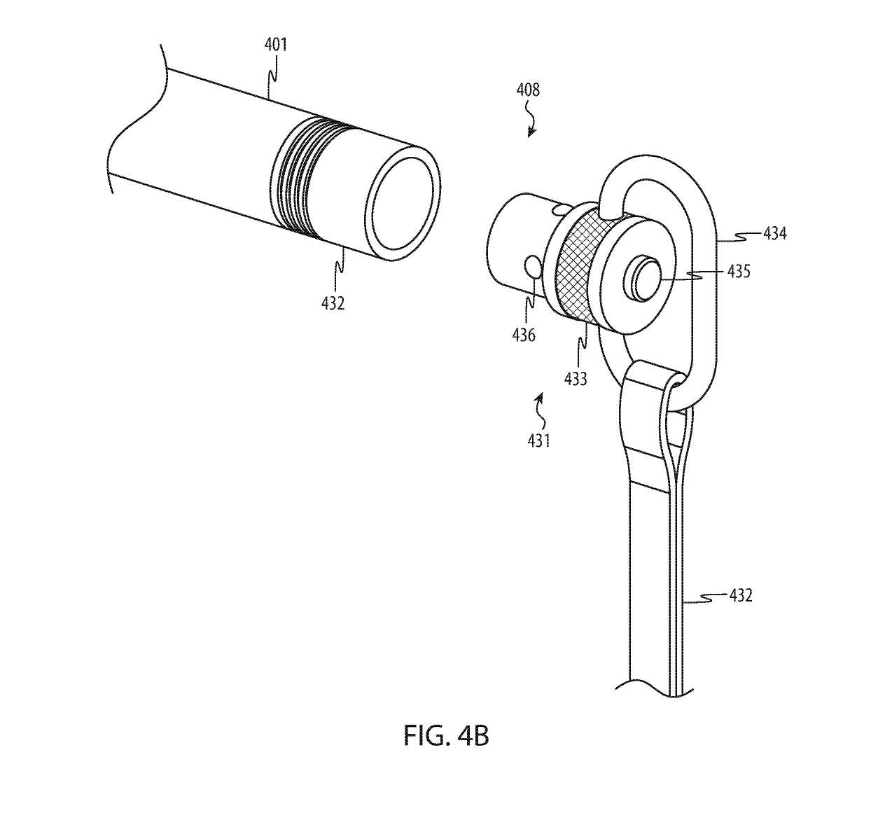

By way of another example, FIGS. 4A-4B depict a second alternative embodiment of connection between the rod 401 and the strap 402. In this alternative embodiment, the second end 408 of the rod 401 includes a swivel assembly 431.

The swivel assembly 431 may include a base portion 432 connected to a loop portion 433. The loop portion 433 may include a loop 434 to which the strap 402 is operable to attach. The loop portion 433 may be operable to rotate with respect to the base portion 432.

The swivel assembly 431 may resist removal of the strap 402 from the second end 408 of the rod 401. The base portion 432 and loop portion 433 may first be disconnected before the strap 402 is removed from the second end 408 of the rod 401. Downward force on the swivel assembly 431 by the strap 402 during use may prevent the swivel assembly 431 from rotating and allowing motion of the rod 401, but the swivel assembly 431 may rotate when the apparatus is not in use to allow motion of the swivel assembly 431, the strap 402, and/or the rod 401 for adjustment of various components with respect to each other.

The loop portion 433 may also be removable from the base portion 432. As such, in this implementation, the loop portion 433 may function as a clip that inserts into the base portion 432, which may function as a clip mount. For example, the loop portion 433 may include a button 435 or other removal activation mechanism. FIG. 4A shows the base portion 432 and the loop portion 433 coupled. FIG. 4B shows the loop portion 433 removed from the base portion.

As shown in FIG. 4B, an end of the loop portion 433 opposite the loop 434 may be sized smaller than an aperture of the base portion 432 so that it is operable to insert into the aperture. One or more detents 436 or other restraint/movement mechanisms may be positioned thereon.

The detents 436 may assist rotation of the loop portion 433 with respect to the base portion 432. The detents 436 may also prevent removal of the loop portion 433 from the base portion 432. Activation of the button 434 may allow the detents 436 to move so that the loop portion 433 is able to separate from the base portion 432.

However, it is understood that this is an example. In various implementations, the base portion 432 and the loop portion 433 may connect, disconnect, and rotate using a variety of mechanisms other than those shown and described above. Various configurations are possible and contemplated without departing from the scope of the present disclosure.

As described above and illustrated in the accompanying figures, the present disclosure relates to a hands-free apparatus for using photographic equipment, such a smart phone, during activities, such as fishing. The hands-free photographic apparatus may include a rod, shaft, or other photographic device mounting member that is operable to rest on a user's shoulder and suspend a photographic device on a first end in front of the user at a distance and position where it may be usable to record one or more images of the user. The hands-free photographic apparatus may also include a strap, restraint, or other counterbalance mechanism that exerts a downward force or otherwise counterbalances or restricts motion of the hands-free apparatus off of the user's shoulder caused by the photographic device. The hands-free photographic apparatus may further include a shoulder mount, securement mechanisms, restraining portions, or other grip mechanism that secures, prevents sliding, or otherwise restricts motion of the hands-free photographic apparatus on the user's shoulder. The hands-free photographic apparatus may be quickly and simply assembled and disassembled and allow use of the photographic device while a user engages in various activities, such as fishing.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A hands-free photographic apparatus, comprising:
a shoulder mount positionable on a user's shoulder, the shoulder mount including a first securement mechanism;
a rod operable to balance on the shoulder mount, the rod comprising:
a first end;
a second end;
a photographic device mount coupled to the first end such that the photographic device mount is operable to suspend a photographic device from the rod when the rod is positioned on the shoulder mount and the shoulder mount is positioned on the user's shoulder; and
a second securement mechanism positioned between the first end and the second end that is operable to engage the first securement mechanism to secure the rod to the shoulder mount; and
a strap connected to an attachment point located on a user's torso and the second end of the rod, the strap operable to counterbalance the photographic device.

2. The hands-free photographic apparatus of claim 1, wherein the shoulder mount is configured to couple to a shoulder strap.

3. The hands-free photographic apparatus of claim 1, wherein the first and second securement mechanisms comprise a set of interacting hook-and-loop fasteners.

4. The hands-free photographic apparatus of claim 1, wherein the first and second securement mechanisms comprise a set of interacting magnets.

5. The hands-free photographic apparatus of claim 1, wherein the rod is a telescoping rod.

6. The hands-free photographic apparatus of claim 1, wherein the strap includes a loop that wraps around the second end of the rod.

7. The hands-free photographic apparatus of claim 1, wherein the attachment point comprises a belt loop and the strap includes a loop that wraps around the belt loop.

8. A hands-free photographic apparatus, comprising:
a shaft positionable on a user's shoulder, the shaft comprising:
a photographic device mount coupled to a first end of the shaft that is operable to suspend a photographic device from the shaft; and
a restraining portion operable to restrict motion of the shaft when the shaft is positioned on the user's shoulder; and
a counterbalance mechanism connected to the user's torso and a second end of the shaft that resists a downward force exerted on the first end of the shaft by the photographic device.

9. The hands-free photographic apparatus of claim 8, wherein the counterbalance mechanism includes a clip that is operable to engage an aperture in a clip mount rotatably attached to the second end of the shaft.

10. The hands-free photographic apparatus of claim 8, wherein the counterbalance mechanism is removably connected to the second end of the shaft.

11. The hands-free photographic apparatus of claim 8, wherein the second end of the shaft is configured to resist disconnection of the counterbalance mechanism.

12. The hands-free photographic apparatus of claim 8, wherein the counterbalance mechanism includes a first set of hook-and-loop fasteners and a second set of hook-and-loop fasteners.

13. The hands-free photographic apparatus of claim 8, wherein the photographic device comprises a cellular telephone.

14. The hands-free photographic apparatus of claim 8, wherein the shaft is configurable between a first length and a second length.

15. A hands-free photographic apparatus, comprising:
a photographic device mounting member configured to rest on a user's shoulder, suspend a photographic device on a first side of the user's shoulder, and extend over a second side of the user's shoulder;
a restraint connected to the user's waist and the portion of the photographic device mounting member extending over the second side of the user's shoulder, the restraint restricting motion of the photographic device mounting member off of the user's shoulder caused by the photographic device; and
a grip mechanism that prevents sliding of the photographic device mounting member on the user's shoulder.

16. The hands-free photographic apparatus of claim 15, wherein the photographic device mounting member allows repositioning of the photographic device with respect to the user while resting on the user's shoulder.

17. The hands-free photographic apparatus of claim 15, wherein the restraint compensates the photographic device mounting member for a weight of the photographic device.

18. The hands-free photographic apparatus of claim 17, wherein the restraint is operable to compensate the photographic device mounting member for the weight of the photographic device at multiple distances from the user.

19. The hands-free photographic apparatus of claim 15, wherein the restraint comprises a stretchable cord.

20. The hands-free photographic apparatus of claim 15, wherein the photographic device is a mobile computing device.
